(19) United States
(12) Patent Application Publication
(10) Pub. No.: US 2024/0259924 A1
(43) Pub. Date: Aug. 1, 2024

(54) METHOD AND APPARATUS FOR DETERMINING DISCOVERY BURST TRANSMISSION WINDOW, AND STORAGE MEDIUM

(71) Applicant: Beijing Xiaomi Mobile Software Co., Ltd., Beijing (CN)

(72) Inventor: Yang LIU, Beijing (CN)

(73) Assignee: Beijing Xiaomi Mobile Software Co., Ltd., Beijing (CN)

(21) Appl. No.: 18/561,192

(22) PCT Filed: May 17, 2021
(86) PCT No.: PCT/CN2021/094188

§ 371 Date: Nov. 15, 2023

(51) Int. Cl. H04W 48/16; H04L 5/00; H04W 48/10

(52) U.S. Cl. CPC H04W 48/16; H04L 5/0048; H04W 48/10

(57) ABSTRACT

A method, apparatus, and computer readable medium for determining a discovery burst transmission window (DBTW). The DBTW is determined by determining a working frequency band in an initial access process of a terminal, and determining the DBTW length used by the terminal to transmit a synchronization signal block (SSB) in the initial access process of the working frequency band; and sending the DBTW length. A method for determining a DBTW is performed by a terminal, and the method for determining a DBTW includes: determining a working frequency band according to an initial search procedure; and determining, on the basis of the working frequency band, the DBTW length used in at initial access process for transmitting an SSB.

### CROSS-REFERENCE TO RELATED APPLICATION

The present application is a U.S. National Phase of International Patent Application Serial No. PCT/CN2021/094188 filed on May 17, 2021. The entire contents of the above-cited application are hereby incorporated by reference in their entirety for all purposes.

### BACKGROUND

As the communication technology develops, a higher frequency band is applied to communication, which supports 52.6 GHz-71 GHz for example. Wider sub-carrier spacing (SCS) such as 960 kHz is employed for designing a frequency spectrum for 52.6 GHz-71 GHz. That is, the sub-carrier spacing supported during data transmission in a higher frequency band can support 960 k, as well as 480 kHz, 240 kHz, 120 kHz, and 60 kHz selectively.

### SUMMARY

In order to overcome the problems in the related art, the disclosure provides a method and apparatus for determining a discovery burst transmission window, and a storage medium.

In a first aspect, a method for determining a discovery burst transmission window (DBTW) is provided in an example of the disclosure. The method for determining a DBTW is performed by a network device and includes:
determining a working frequency band in an initial access process of a terminal, and determining a DBTW length used by the terminal to transmit in the working frequency band a synchronization signal and physical broadcast channel block in the initial access process; and sending the DBTW length.

In a second aspect, a method for determining a discovery burst transmission window (DBTW) is provided in an example of the disclosure. The method for determining a DBTW is performed by a terminal and includes:
determining a working frequency band according to an initial search procedure; and
determining a DBTW length used in transmission of a synchronization signal and physical broadcast channel block in an initial access process based on the working frequency band.

In a third aspect, a network device is provided in an example of the disclosure. The network device includes:

a processor; and a memory configured to store a processor-executable instruction; where

the processor is configured to execute the method for determining a DBTW in the first aspect.

In a fourth aspect, a terminal is provided in an example of the disclosure. The terminal includes:
a processor; and a memory configured to store a processor-executable instruction; where
the processor is configured to execute the method for determining a DBTW in the second aspect.

In a fifth aspect, a storage medium is provided in an example of the disclosure. The storage medium stores an instruction, where when executed by a processor of a network device, the instruction in the storage medium causes the network device to execute the method for determining a DBTW in the first aspect.

In a sixth aspect, a storage medium is provided in an example of the disclosure. The storage medium stores an instruction, where when executed by a processor of a terminal, the instruction in the storage medium causes the terminal to execute the method for determining a DBTW in the second aspect.

It should be understood that the above general description and the following detailed description are merely illustrative and explanatory and cannot limit the disclosure.

### BRIEF DESCRIPTION OF THE DRAWINGS

The accompanying drawings here are incorporated in the description as a constituent part of the description, illustrate examples conforming to the disclosure, and serve to explain the principles of the disclosure along with the description.

FIG. 1 is a schematic diagram of a radio communication system according to an example;

FIG. 2 is a schematic diagram of a frequency spectrum having sub-carrier spacing of 120 kHz and 64 synchronization signal and physical broadcast channel physical broadcast channel blocks (SSBs) transmitted according to an example;

FIG. 3 is a schematic diagram of a frequency spectrum having sub-carrier spacing of 240 kHz and 64 SSBs transmitted according to an example;

FIG. 4 is a flowchart of a method for determining a discovery burst transmission window (DBTW) according to an example;

FIG. 5 is a flowchart of a method for determining a DBTW according to an example;

FIG. 6 is a flowchart of a method for determining a DBTW according to an example;

FIG. 7 is a flowchart of a method for determining a DBTW according to an example;

FIG. 8 is a flowchart of a method for determining a DBTW according to an example;

FIG. 9 is a flowchart of a method for determining a DBTW according to an example;

FIG. 10 is a flowchart of a method for determining a DBTW according to an example;

FIG. 11 is a block diagram of an apparatus for determining a DBTW according to an example;

FIG. 12 is a block diagram of an apparatus for determining a DBTW according to an example;

FIG. 13 is a block diagram of an apparatus for determining a DBTW according to an example; and

FIG. 14 is a block diagram of an apparatus for determining a DBTW according to an example.

### DETAILED DESCRIPTION

Examples will be described in detail here and are illustratively shown in the accompanying drawings. When the accompanying drawings are involved in the following description, the same numbers in different accompanying drawings denote the same or similar elements unless otherwise indicated. The embodiments described in the following examples do not denote all embodiments consistent with the disclosure. On the contrary, the embodiments are merely instances of apparatuses and methods consistent with some aspects of the disclosure as recited in the appended claims.

The disclosure relates to the technical field of communication, and in particular to a method and apparatus for determining a discovery burst transmission window, and a storage medium.

Burst transmission is principally based on a 5th generation mobile communication (5G) frequency band (FR) 2 (7.126-52.6) in the related art. For example, a terminal transmits a discovery burst (DB) in an initial access phase. A discovery burst transmission window (DBTW) is configured when the DB is transmitted in the related art.

In the 5G FR2 (7.126-52.6), two kinds of sub-carrier spacing of 120 kHz/60 kHz are used in data, and two kinds of sub-carrier spacing of 240 kHz/120 kHz are used in a synchronization signal and physical broadcast channel (PBCH) block (SSB). Moreover, a candidate SSB can be arranged to improve transmission reliability. For 52.6 GHz-71 GHz, more SSBs need to be transmitted, so that there may be no room for the candidate SSB. However, it is impossible to configure the DBTW through signaling in the initial access phase, thus affecting SSB transmission.

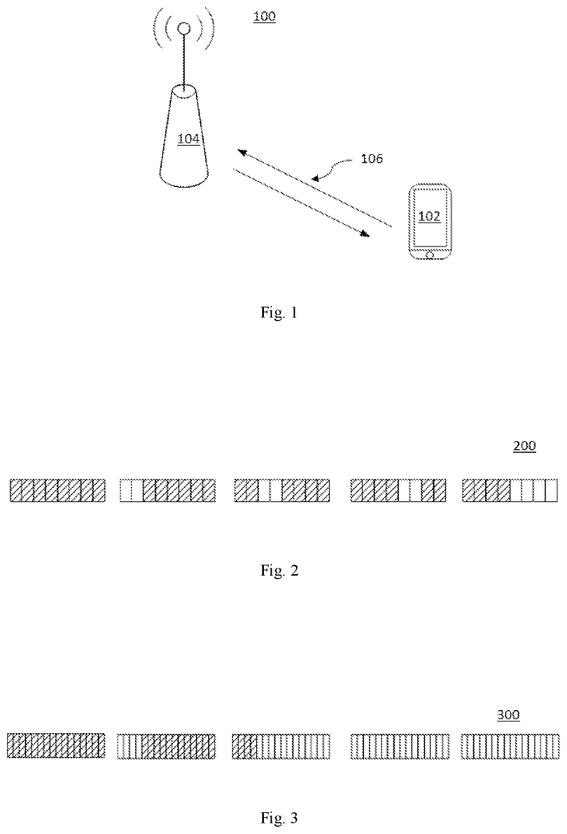

A method for determining a discovery burst transmission window (DBTW) according to an example of the disclosure may be performed by a radio communication system shown in FIG. 1. With reference to FIG. 1, the radio communication system 100 includes a terminal 102 and a network device 104. The terminal is connected to the network device through a radio resource 106 and transmits and receives data.

It can be understood that the radio communication system 100 shown in FIG. 1 is merely schematic and may also include other network devices, for example, core network devices, radio relay devices, radio backhaul devices, etc., which are not depicted in FIG. 1. The number of the network device and the number of the terminal included in the radio communication system are not limited in the example of the disclosure.

It can be further understood that the radio communication system according to the example of the disclosure is a network providing a radio communication function. The radio communication system may employ different communication techniques, such as code division multiple access (CDMA), wideband code division multiple access (WCDMA), time division multiple access (TDMA), frequency division multiple access (FDMA), orthogonal frequency-division multiple access (OFDMA), single carrier frequency division multiple access (SC-FDMA), and carrier sense multiple access with collision avoidance. According to different network capacities, rates, delay, etc., the network can be divided into a second generation (2G) network, a 3G network, a 4G network or a future evolution network, such as a 5G network, and the 5G network can also be referred to as a new radio (NR) network. For the sake of description, a radio communication network may be simply referred to as a network in the disclosure sometimes.

Further, the network device involved in the disclosure may also be referred to as a radio access network device. The radio access network device may be a base station, an evolved node B (eNB), a home base station, an access point (AP) in a wireless fidelity (WIFI) system, a radio relay node, a radio backhaul node, a transmission point (TP) or a transmission and reception point (TRP), etc. The radio access network device may also be a next generation node B (gNB) in an NR system or an assembly or some devices constituting a base station. In the case of a vehicle-to-everything (V2X) communication system, the network device may also be a vehicle-mounted device. It should be understood that a specific technology and a specific device form employed by the network device are not limited in the example of the disclosure.

Further, the terminal involved in the disclosure, which may also be referred to as a terminal device, user equipment (UE), a mobile station (MS), a mobile terminal (MT), etc., is a device that provides voice and/or data connectivity for a user. For example, the terminal may be a handheld device, a vehicle-mounted device, etc. having a radio connection function. At present, some examples of the terminal are a mobile phone, a pocket personal computer (PPC), a palm computer, a personal digital assistant (PDA), a laptop computer, a tablet computer, a wearable device, or a vehicle-mounted device, etc. In addition, in the case of the vehicle to everything (V2X) communication system, the terminal device may also be a vehicle-mounted device. It should be understood that a specific technology and a specific device form employed by the terminal are not limited in the example of the disclosure.

In the new radio (NR), the terminal and the network device support a communication frequency band of frequency range 2 (FR2) 7.126-52.6. In the 5G FR2 (7.126-52.6), two kinds of sub-carrier spacing of 120 kHz/60 kHz are used in data, and two kinds of sub-carrier spacing of 240 kHz/120 kHz are used in SSBs.

In a communication technology in the future, a communication frequency band used in communication between the terminal and the network device will support a higher communication frequency band than FR2 (7.126-52.6) supported by the 5G radio (NR). For example, the communication between the terminal and the network device will support 52.6 GHz-71 GHz.

For a communication frequency band NR 52.6 GHz-71 GHZ, the terminal is supported to transmit a discovery burst and perform initial access based on an initial search procedure. In the related art, for the communication range NR 52.6 GHz-71 GHz, a discovery burst (DB) transmission manner, which is the same as that in section 4.0 of Release (Rel)-16 37.213, is defined. For example, a DBTW configuration of the SSB supporting sub-carrier spacing (SCS) of at least 120 kHz is defined. The DBTW configuration is as follows: the payload of a physical broadcast channel (PBCH) is not greater than that of a PBCH in FR2, a DBTW time is not longer than 5 ms, and the number of demodulation reference signal (DMRS) sequences in the PBCH is the same as that in FR2.

The communication frequency band NR 52.6-71 GHz is suitable for a DBTW design from 120 kHz to the SSB, has SCS of 480 kHz and 960 kHz, and supports a prompt or notification mechanism for enabling/disabling the DBTW in an idle state and a connected state of the terminal.

In the related art, a candidate SSB may be arranged to improve transmission reliability. There may be a candidate SSB position in the FR2 (7.126-52.6). With reference to FIGS. 2 and 3, FIG. 2 is a schematic diagram of a frequency spectrum 200 having sub-carrier spacing of 120 kHz and 64 SSBs transmitted, and FIG. 3 is a schematic diagram of a frequency spectrum 300 having sub-carrier spacing of 240 kHz and 64 SSBs transmitted.

For the NR 52.6 GHz-71 GHz, wider sub-carrier spacing should be used, but 120 kHz is also feasible, which results in more combinations. In the case of 120 kHz, all the 64 SSBs or more than 32 SSBs are transmitted in a default DBTW length (5 ms), and thus there is no room for the candidate SSB. In the case of the NR 52.6 GHZ-71 GHZ, the DBTW could be used in a shared spectrum instead of a licensed spectrum. Moreover, an SSB having a new SCS, such as 480 kHz/960 kHz is added. For the new SCS, a DBTW length may be shorter without being configured as 5 ms. For initial access, it is impossible to configure the DBTW through signaling, and thus, a method for determining a DBTW is to be provided.

A method for determining a DBTW is provided in an example of the disclosure. The method for determining a DBTW includes: based on a working frequency band in an initial access process of a terminal, a DBTW length used by the terminal to transmit in the working frequency band an SSB in the initial access process is determined. Accordingly, the DBTW length in the initial access process is determined in the communication frequency band NR 52.6 GHz-71 GHz.

In an embodiment, the DBTW length used by the terminal in the initial access process may be explicitly indicated in the example of the disclosure. In an example, the DBTW length is indicated, through a PBCH indication information. In another embodiment, the DBTW length used by the terminal in the initial access process may be implicitly indicated in the example of the disclosure.

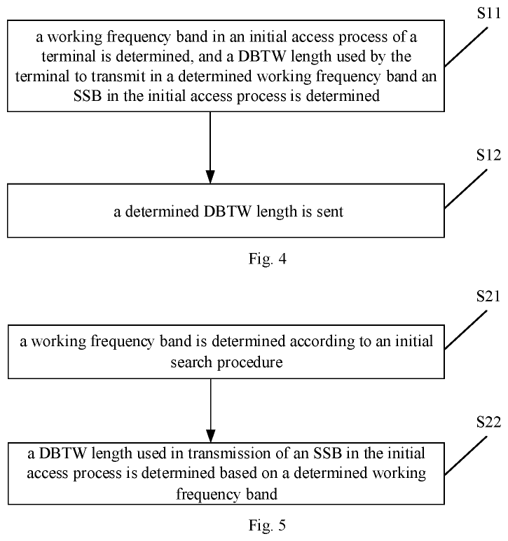

FIG. 4 is a flowchart of a method for determining a DBTW according to an example. As shown in FIG. 4, the method for determining a DBTW is used in a network device and includes:

S11, a working frequency band in an initial access process of a terminal is determined, and a DBTW length used by the terminal to transmit in a determined working frequency band an SSB in the initial access process is determined.

S12, a determined DBTW length is sent.

In the example of the disclosure, the network device determines the working frequency band in the initial access process of the terminal, which is specifically to send a burst in the working frequency band. The terminal searches for the burst through an initial search procedure and determines the working frequency band in the initial access process of the terminal according to the burst. Moreover, after determining the above working frequency band of the terminal, the network device may determine and send the DBTW length used by the terminal to transmit in the working frequency band the SSB in the initial access process. After receiving the DBTW length sent by the network device, the terminal may determine the DBTW length used in the initial access process. Accordingly, the DBTW length in the initial access process is determined in the communication frequency band NR 52.6 GHz-71 GHz.

In the example of the disclosure, the network device may send a determined DBTW length to the terminal based on indication information.

In an example, the network device sends PBCH indication information configured to indicate the DBTW length.

In the example of the disclosure, the working frequency band in the initial access process of the terminal determined by the network device includes a licensed spectrum, a shared spectrum, or a multiplexed frequency band of a licensed spectrum and a shared spectrum.

In the example of the disclosure, under the condition that the working frequency band in the initial access process of the terminal is the licensed spectrum, the DBTW length is not required to be indicated typically. While under the condition that the working frequency band in the initial access process of the terminal is the shared spectrum or the multiplexed frequency band of the licensed spectrum and the shared spectrum, the DBTW length is indicated.

Under the condition that the working frequency band of the terminal determined by the network device is the shared spectrum, the DBTW length may be determined based on SCS.

In the example of the disclosure, the DBTW length indicated through the PBCH indication information is determined in response to determining that the working frequency band of the terminal determined by the network device is the shared spectrum and the sub-carrier spacing is greater than a sub-carrier spacing threshold.

In an example, the PBCH indication information is configured to indicate the DBTW length for initial access employing SCS 480 kHz/960 kHz in the example of the disclosure.

In the example of the disclosure, the PBCH indication information indicates specific DBTW lengths, for example, 5 ms and 2.5 ms.

In an embodiment of the example of the disclosure, the PBCH indication information may indicate one or more DBTW lengths.

When the PBCH indication information indicates a plurality of DBTW lengths, different DBTW lengths of the plurality of DBTW lengths are correspondingly configured with different numbers of candidate SSBs.

In the method for determining a DBTW according to the example of the disclosure, under the condition that the DBTW length is indicated through the PBCH indication information, the indication may be performed through a bit.

In the example of the disclosure, if the PBCH indication information indicates two DBTW lengths, for example, 5 ms and 2.5 ms, the two DBTW lengths may be carried in one bit of SCS of a PBCH.

In an example, the PBCH indication information indicates specific DBTW lengths (5 ms and 2.5 ms), and different DBTW configurations correspond to different numbers of candidates. Further, since a wide range of operators support single SCS operations of SSBs and data for SCS 480 kHz/960 kHz, one bit of the SCS in the PBCH may be used to indicate the DBTW lengths (5 ms and 2.5 ms).

In the example of the disclosure, when the working frequency band of the terminal is the shared spectrum, and the sub-carrier spacing is less than the sub-carrier spacing threshold, the DBTW length may be indicated implicitly. For example, a default DBTW length is employed.

In an example, for initial access employing SCS 120 KHZ/240 kHz, 5 ms is taken as a default DBTW length configuration implicitly.

In the example of the disclosure, the network device indicates the DBTW length through the PBCH indication information, so that the terminal may determine the DBTW length used in the initial access process based on the PBCH indication information.

A method for determining a DBTW is provided in an example of the disclosure. The method for determining a DBTW is performed by a terminal and includes: the terminal determines a working frequency band according to an initial search procedure and determines a DBTW length used in transmission of an SSB in an initial access process based on a determined working frequency band. Accordingly, the DBTW length in the initial access process is determined in the communication frequency band NR 52.6 GHz-71 GHz.

FIG. 5 is a flowchart of a method for determining a DBTW according to an example. As shown in FIG. 5, the method for determining a DBTW is used in a terminal and includes:

S21, a working frequency band is determined according to an initial search procedure.

In the example of the disclosure, the initial search procedure is configured to search for a burst sent by a network device. The terminal searches for the burst sent by the network device according to the initial search procedure and then determines the working frequency band used in the initial access process of the terminal.

S22, a DBTW length used in transmission of an SSB in the initial access process is determined based on a determined working frequency band.

In the example the disclosure, the terminal may search for the burst sent by the network device in the determined working frequency band through the initial search procedure, so as to determine the working frequency band in the initial access process of the terminal. Moreover, the terminal may determine the DBTW length used in the initial access process, so as to determine the DBTW length in the initial access process in the communication frequency band NR 52.6 GHz-71 GHz.

In the example of the disclosure, the working frequency band determined by the terminal according to the initial search procedure includes a licensed spectrum, a shared spectrum, or a multiplexed frequency band of a licensed spectrum and a shared spectrum.

In an embodiment, under the condition that the working frequency band of the terminal is the shared spectrum, the DBTW length may be determined based on SCS.

In the example of the disclosure, the DBTW length used in the transmission of the SSB in the initial access process is determined in response to determining that the working frequency band of the terminal is the shared spectrum and sub-carrier spacing is greater than a sub-carrier spacing threshold.

In an example, the terminal may determine the DBTW length used in the transmission of the SSB in the initial access process based on indication information sent by the network device and configured to indicate the DBTW length in the example of the disclosure.

For example, in the example of the disclosure, the DBTW length used in the transmission of the SSB in the initial access process may be determined through PBCH indication information.

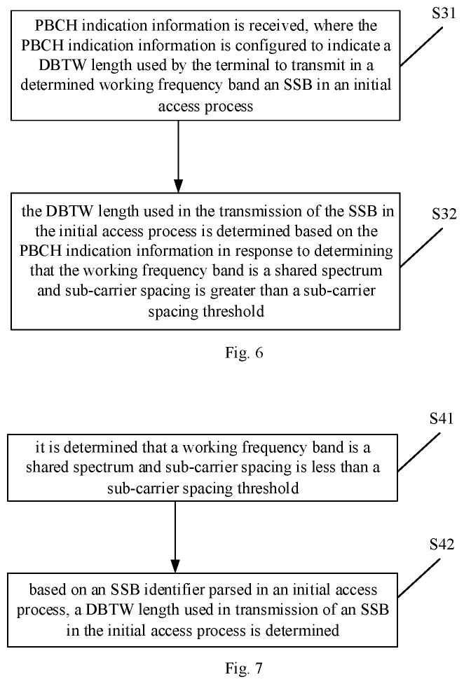

FIG. 6 is a flowchart of a method for determining a DBTW according to an example. As shown in FIG. 6, the method for determining a DBTW is used in a terminal and includes:

S31, PBCH indication information is received, where the PBCH indication information is configured to indicate a DBTW length used by the terminal to transmit in a determined working frequency band an SSB in an initial access process.

S32, the DBTW length used in the transmission of the SSB in the initial access process is determined based on the PBCH indication information in response to determining that the working frequency band is a shared spectrum and sub-carrier spacing is greater than a sub-carrier spacing threshold.

In an example, the terminal may determine the DBTW length based on the PBCH indication information for initial access employing SCS 480 kHz/960 kHz in the example of the disclosure.

In the example of the disclosure, the PBCH indication information indicates specific DBTW lengths, for example, 5 ms and 2.5 ms.

In an embodiment of the example of the disclosure, the PBCH indication information may indicate one or more DBTW lengths.

When the PBCH indication information indicates a plurality of DBTW lengths, different DBTW lengths of the plurality of DBTW lengths are correspondingly configured with different numbers of candidate SSBs.

In the method for determining a DBTW according to the example of the disclosure, under the condition that the DBTW length is indicated through the PBCH indication information, the indication may be performed through a bit.

In the example of the disclosure, if the PBCH indication information indicates two DBTW lengths, for example, 5 ms and 2.5 ms, the two DBTW lengths may be carried in one bit of SCS of a PBCH.

In an example, the PBCH indication information indicates specific DBTW lengths (5 ms and 2.5 ms), and different DBTW configurations correspond to different numbers of candidates. Further, since a wide range of operators support single SCS operations of SSBs and data for SCS 480 kHz/960 kHz, one bit of the SCS in the PBCH may be used to indicate the DBTW lengths (5 ms and 2.5 ms).

When the working frequency band of the terminal is the shared spectrum, and the sub-carrier spacing is less than the sub-carrier spacing threshold, the DBTW length may be indicated implicitly. For example, a default DBTW length is employed.

In an example, for initial access employing SCS 120 khZ/240 kHz, 5 ms is taken as a default DBTW length configuration implicitly.

In the example of the disclosure, the DBTW length used in the transmission of the SSB in the initial access process is determined based on an SSB identifier (SSB ID) parsed in the initial access process in response to determining that the working frequency band is the shared spectrum and the sub-carrier spacing is less than the sub-carrier spacing threshold. Accordingly, the situation that there is no room for a candidate SSB is avoided.

FIG. 7 is a flowchart of a method for determining a DBTW according to an example. As shown in FIG. 7, the method for determining a DBTW is used in a terminal and includes:

S41, it is determined that a working frequency band is a shared spectrum and sub-carrier spacing is less than a sub-carrier spacing threshold.

S42, based on an SSB identifier parsed in an initial access process, a DBTW length used in the transmission of an SSB in the initial access process is determined.

In the method for determining a DBTW according to the example of the disclosure, if the SSB identifier parsed in the initial access process is greater than an identifier threshold, it is determined that no DBTW is used in the transmission of the SSB in the initial access process. Accordingly, the situation that there is no room for a candidate SSB is avoided, and the reliability of communication transmission is improved.

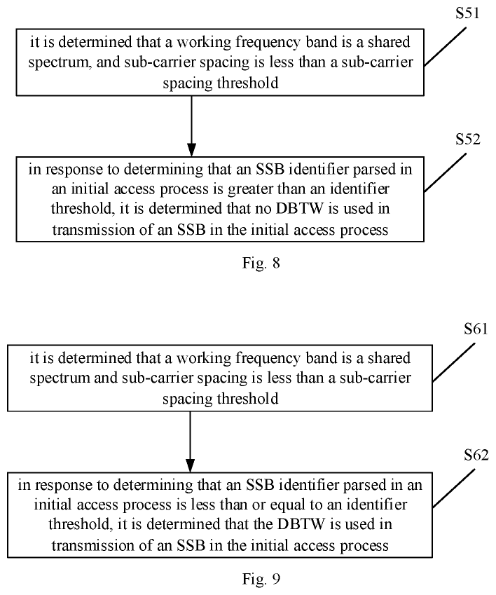

FIG. 8 is a flowchart of a method for determining a DBTW according to an example. As shown in FIG. 8, the method for determining a DBTW is used in a terminal and includes:

S51, it is determined that a working frequency band is a shared spectrum, and sub-carrier spacing is less than a sub-carrier spacing threshold.

S52, in response to determining that an SSB identifier parsed in an initial access process is greater than an identifier threshold, it is determined that no DBTW is used in transmission of an SSB in the initial access process.

For example, for initial access employing SCS 120 kHz, if an SSB ID parsed by the terminal in the initial access process is greater than the identifier threshold (for example, 32), it may be indicated implicitly that no DBTW is used.

In the method for determining a DBTW according to the example of the disclosure, it is determined that the DBTW is used in the transmission of the SSB in the initial access process in response to determining that the SSB identifier parsed in the initial access process is less than or equal to the identifier threshold.

FIG. 9 is a flowchart of a method for determining a DBTW according to an example. As shown in FIG. 9, the method for determining a DBTW is used in a terminal and includes:

S61, it is determined that a working frequency band is a shared spectrum and sub-carrier spacing is less than a sub-carrier spacing threshold.

S62, in response to determining that an SSB identifier parsed in an initial access process is less than or equal to an identifier threshold, it is determined that the DBTW is used in the transmission of an SSB in the initial access process.

Under the condition that the SSB identifier parsed in the initial access process is less than or equal to the identifier threshold, a DBTW length used in the transmission of the SSB in the initial access process is a default DBTW length. For example, the DBTW length may be 5 ms.

In the example of the disclosure, under the condition that the working frequency band in the initial access process of the terminal is a licensed spectrum, no DBTW is required to be used typically.

In the example of the disclosure, under the condition that the working frequency band in the initial access process of the terminal is a multiplexed frequency band of a licensed spectrum and a shared spectrum, the DBTW may be used or not.

In an example, if the working frequency band in the initial access process of the terminal is the multiplexed frequency band of the licensed spectrum and the shared spectrum, the terminal receives PBCH indication information configured to indicate the DBTW length, determines to use the DBTW, and may determine the DBTW length used in the transmission of the SSB in the initial access process based on the PBCH indication information.

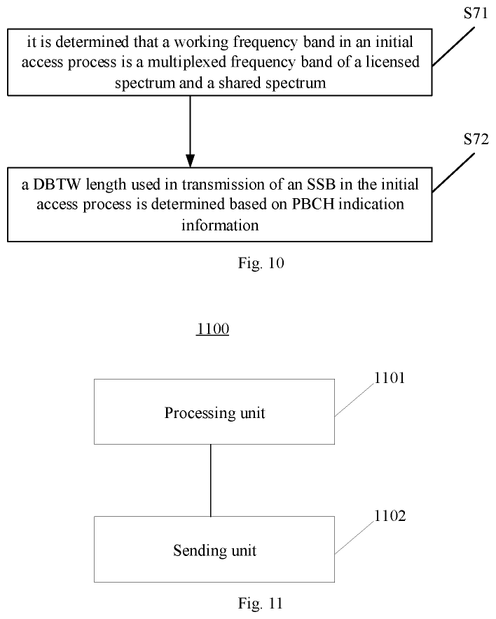

FIG. 10 is a flowchart of a method for determining a DBTW according to an example. As shown in FIG. 10, the method for determining a DBTW is used in a terminal and includes:

S71, it is determined that a working frequency band in an initial access process is a multiplexed frequency band of a licensed spectrum and a shared spectrum.

S72, a DBTW length used in the transmission of an SSB in the initial access process is determined based on PBCH indication information.

In the example of the disclosure, under the condition that the working frequency band in the initial access process is the multiplexed frequency band of the licensed spectrum and the shared spectrum, the DBTW length used in the transmission of the SSB in the initial access process may be determined in the manner based on PBCH indication information involved in the above example. For example, the PBCH indication information indicates specific DBTW lengths, for example, 5 ms and 2.5 ms.

In an embodiment of the example of the disclosure, the PBCH indication information may indicate one or more DBTW lengths.

When the PBCH indication information indicates a plurality of DBTW lengths, different DBTW lengths of the plurality of DBTW lengths are correspondingly configured with different numbers of candidate SSBs.

In the method for determining a DBTW according to the example of the disclosure, under the condition that the DBTW length is indicated through the PBCH indication information, the indication may be performed through a bit.

In the example of the disclosure, if the PBCH indication information indicates two DBTW lengths, for example, 5 ms and 2.5 ms, the two DBTW lengths may be carried in one bit of SCS of a PBCH.

In the method for determining a DBTW according to the example of the disclosure, the terminal implicitly or explicitly determines the DBTW length in the initial access process. Accordingly, the terminal determines the DBTW length in the initial access process in the communication frequency band NR 52.6 GHz-71 GHz.

It can be understood that the method for determining a DBTW according to the example of the disclosure is applicable to a process of determining the DBTW length in the initial access process in the communication frequency band NR 52.6 GHz-71 GHz during an interaction between the network device and the terminal. The process of determining the DBTW length in the initial access process in the communication frequency band NR 52.6 GHz-71 GHz during the interaction between the network device and the terminal will not be described in detail in the example of the disclosure.

It should be noted that those skilled in the art can understand that various embodiments/examples described above in the examples of the disclosure can be used in conjunction with the foregoing examples or alone. Whether used alone or in conjunction with the foregoing examples, the embodiments/examples have similar implementation principles. In the example of the disclosure, some examples are described in terms of the embodiments used together. Certainly, those skilled in the art can understand that such illustrations are not intended to limit the examples of the disclosure.

Based on the same concept, an apparatus for determining a DBTW is further provided in an example of the disclosure.

It can be understood that in order to realize the above functions, the apparatus for determining a DBTW, according to the example of the disclosure, includes corresponding hardware structures and/or software modules configured to execute all the functions. The examples of the disclosure, in combination with units and algorithm steps in each example disclosed in the examples of the disclosure, can be implemented in the form of hardware or a combination of hardware and computer software. Whether a certain function is executed through the hardware or by driving the hardware through the computer software depends on specific application and design constraint conditions of the technical solutions. Those skilled in the art can implement the described functions through different methods for each particular application, but such implementation should not be deemed to be beyond the scope of the technical solutions of the examples of the disclosure.

FIG. 11 is a block diagram of an apparatus for determining a DBTW according to an example. With reference to FIG. 11, the apparatus 1100 for determining a DBTW is performed by a network device and includes a processing unit 1101 and a sending unit 1102; where

the processing unit 1101 is configured to determine a working frequency band in an initial access process of a terminal, and determine a DBTW length used by the terminal to transmit in the working frequency band an SSB in the initial access process; and the sending unit 1102 is configured to send the DBTW length.

In an embodiment, the sending unit 1102 is configured to send PBCH indication information, where the PBCH indication information is configured to indicate the DBTW length.

In an embodiment, the PBCH indication information is configured to indicate one or more DBTW lengths.

In an embodiment, the PBCH indication information is configured to indicate a plurality of DBTW lengths, where different DBTW lengths of the plurality of DBTW lengths are correspondingly configured with different numbers of candidate SSBs.

In an embodiment, the PBCH indication information is configured to indicate two DBTW lengths, and the two DBTW lengths are carried in one bit of sub-carrier indication information of a PBCH.

In an embodiment, the working frequency band includes a licensed spectrum, a shared spectrum, or a multiplexed frequency band of a licensed spectrum and a shared spectrum.

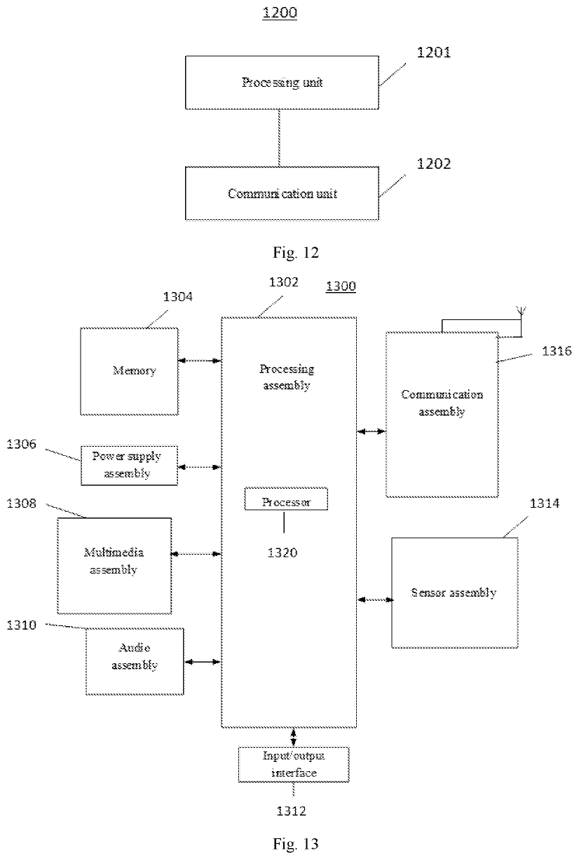

FIG. 12 is a block diagram of an apparatus for determining a DBTW according to an example. With reference to FIG. 12, the apparatus 1200 for determining a DBTW is performed by a terminal and includes a processing unit 1201 and a communication unit 1202; where

the processing unit 1201 is configured to determine a working frequency band according to an initial search procedure; and the communication unit 1202 is configured to determine a DBTW length used in transmission of an SSB in an initial access process based on the working frequency band.

In an embodiment, the communication unit 1202 determines the DBTW length used in the transmission of the SSB in the initial access process based on an SSB identifier parsed in the initial access process in response to determining that the working frequency band is a shared spectrum and sub-carrier spacing is less than a sub-carrier spacing threshold.

In an embodiment, the communication unit 1202 determines that no DBTW is used in the transmission of the SSB in the initial access process in response to determining that an SSB identifier parsed in the initial access process is greater than an identifier threshold.

In an embodiment, the communication unit 1202 determines that the DBTW is used in the transmission of the SSB in the initial access process in response to determining that an SSB identifier parsed in the initial access process is less than or equal to an identifier threshold. In an embodiment, a DBTW length is a default DBTW length.

In an embodiment, the communication unit 1202 is further configured to receive PBCH indication information, where the PBCH indication information is configured to indicate the DBTW length used by the terminal to transmit in the working frequency band the SSB in the initial access process. The communication unit 1202 determines the DBTW length used in the transmission of the SSB in the initial access process based on the PBCH indication information in response to determining that the working frequency band is a shared spectrum and sub-carrier spacing is greater than a sub-carrier spacing threshold.

In an embodiment, the PBCH indication information is configured to indicate one or more DBTW lengths.

In an embodiment, different DBTW lengths are correspondingly configured with different numbers of candidate SSBs.

In an embodiment, the PBCH indication information is configured to indicate two DBTW lengths, and the two DBTW lengths are carried in one bit of sub-carrier indication information of a PBCH.

In an embodiment, the communication unit 1202 determines that no DBTW is used in the transmission of the SSB in the initial access process in response to determining that the working frequency band is a licensed spectrum.

In an embodiment, the communication unit 1202 determines the DBTW length used in the transmission of the SSB in the initial access process based on the PBCH indication information in response to determining that the working frequency band is a multiplexed frequency band of a licensed spectrum and a shared spectrum.

For the apparatus in the above example, the specific way in which each module executes an operation has been described in detail in the example related to the method, which will not be described in detail here.

FIG. 13 is a block diagram of an apparatus 1300 for determining a DBTW according to an example. For example, the apparatus 1300 may be a mobile phone, a computer, a digital broadcast terminal, a message transceiving device, a game console, a tablet device, a medical device, a fitness device, a personal digital assistant, etc.

With reference to FIG. 13, the apparatus 1300 may include one or more of the following assemblies: a processing assembly 1302, a memory 1304, a power supply assembly 1306, a multimedia assembly 1308, an audio assembly 1310, an input/output (I/O) interface 1312, a sensor assembly 1314, and a communication assembly 1316.

The processing assembly 1302 typically controls an overall operation of the apparatus 1300, such as operations associated with display, telephone calls, data communication, camera operations, and recording operations. The processing assembly 1302 may include one or more processors 1320 to execute instructions, so as to complete all or some of the steps of the above methods. In addition, the processing assembly 1302 may include one or more modules that facilitate interaction between the processing assembly 1302 and other assemblies. For example, the processing assembly 1302 may include a multimedia module, so as to facilitate interaction between the multimedia assembly 1308 and the processing assembly 1302.

The memory 1304 is configured to store various types of data to support the operations at the apparatus 1300. For example, these data include instructions for any application or method operating at the apparatus 1300, contact data, phonebook data, messages, pictures, video, etc. The memory 1304 may be implemented by any type of volatile or non-volatile storage devices or a combination of them, such as a static random access memory (SRAM), an electrically erasable programmable read-only memory (EEPROM), an erasable programming read-only memory (EPROM), a programmable read-only memory (PROM), a read-only memory (ROM), a magnetic memory, a flash memory, a magnetic disk, or an optical disk.

The power supply assembly 1306 provides power for various assemblies of the apparatus 1300. The power supply assembly 1306 may include a power source management system, one or more power sources, and other assemblies associated with generation, management, and power distribution for the apparatus 1300.

The multimedia assembly 1308 includes a screen that provides an output interface between the apparatus 1300 and a user. In some examples, the screen may include a liquid crystal display (LCD) and a touch panel (TP). With the touch panel included, the screen may be implemented as a touch screen to receive an input signal from the user. The touch panel includes one or more touch sensors to sense touches, swipes, and gestures on the touch panel. Except for sensing a boundary of a touch or swipe action, the touch sensor may also detect a duration and a pressure associated with a touch or swipe operation. In some examples, the multimedia assembly 1308 includes a front-facing camera and/or a rear-facing camera. When the apparatus 1300 is in an operation mode, such as a photographing mode or a video mode, the front-facing camera and/or the rear-facing camera may receive external multimedia data. Each of the front-facing camera and the rear-facing camera may be a fixed optical lens system or have a focal length and an optical zoom capacity.

The audio assembly 1310 is configured to output and/or input audio signals. For example, the audio assembly 1310 includes a microphone (MIC) configured to receive external audio signals when the apparatus 1300 is in the operation mode, such as a call mode, a recording mode, and a voice recognition mode. The received audio signals may be further stored in the memory 1304 or sent via the communication assembly 1316. In some examples, the audio assembly 1310 further includes a loudspeaker configured to output audio signals.

The I/O interface 1312 provides an interface between the processing assembly 1302 and peripheral interface modules, such as keyboards, click wheels, and buttons. These buttons may include, but are not limited to: a home button, a volume button, a start button, and a lock button.

The sensor assembly 1314 includes one or more sensors configured to provide status assessment of various aspects of the apparatus 1300. For example, the sensor assembly 1314 may detect an opened/closed state of the apparatus 1300, and relative locating of the assemblies, such as a display and a keypad of the apparatus 1300. The sensor assembly 1314 may further detect a change in position of the apparatus 1300 or one assembly of the apparatus 1300, presence or absence of contact between the user and the apparatus 1300, an orientation or acceleration/deceleration of the apparatus 1300, and a change in temperature of the apparatus 1300. The sensor assembly 1314 may include a proximity sensor configured to detect the presence of a nearby object in the absence of any physical contact. The sensor assembly 1314 may further include light sensors, such as a complementary metal-oxide-semiconductor transistor (CMOS) or a charge coupled device (CCD) image sensor for use in imaging application. In some examples, the sensor assembly 1314 may further include an acceleration sensor, a gyroscope sensor, a magnetic sensor, a pressure sensor, or a temperature sensor.

The communication assembly 1316 is configured to facilitate wired or wireless communication between the apparatus 1300 and other devices. The apparatus 1300 may access a radio network based on a communication standard, for example, wireless fidelity (WiFi), 2G, or 3G, or a combination of them. In an example, the communication assembly 1316 receives a broadcast signal or broadcast-associated information from an external broadcast management system via a broadcast channel. In an example, the communication assembly 1316 further includes a near-field communication (NFC) module to facilitate short-range communication. For example, the NFC module may be implemented on the basis of a radio frequency identification (RFID) technology, an infrared data association (IrDA) technology, an ultra wide band (UWB) technology, a Bluetooth (BT) technology, etc.

In an example, the apparatus 1300 may be implemented by one or more application specific integrated circuits (ASICs), digital signal processors (DSPs), digital signal processing devices (DSPDs), programmable logic devices (PLDs), field programmable gate arrays (FPGAs), controllers, microcontrollers, microprocessors, etc. configured to perform the above methods.

A non-transitory computer-readable storage medium including an instruction, such as a memory 1304 including an instruction, is further provided in an example, where the above instruction may be executed by the processor 1320 of the apparatus 1300, so as to complete the above method. For example, the non-transitory computer-readable storage medium may be an ROM, an RAM, a compact disk read-only memory (CD-ROM), a magnetic tape, a floppy disk, an optical data storage device, etc.

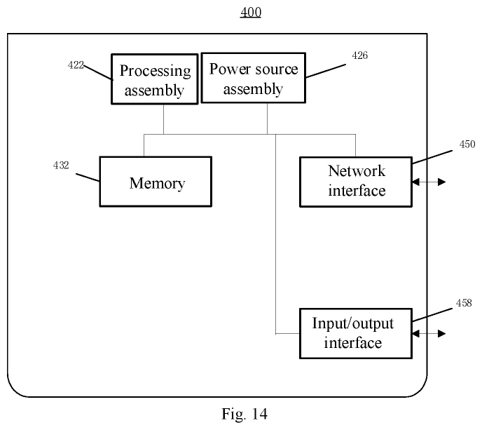

FIG. 14 is a block diagram of an apparatus 400 for determining a DBTW according to an example. For example, the apparatus 400 may be provided as a server. With reference to FIG. 14, the apparatus 400 includes a processing assembly 422, and further includes one or more processors and memory resources represented by a memory 432 configured to store an instruction executable by the processing assembly 422, such as an application. The application stored in the memory 432 may include one or more modules, each of which corresponds to a set of instructions. In addition, the processing assembly 422 is configured to execute the instructions to execute the above methods.

The apparatus 400 may also include a power source assembly 426 configured to execute power source management of the apparatus 400, a wired or wireless network interface 450 configured to connect the apparatus 400 to a network, and an input/output (I/O) interface 458. The apparatus 400 may operate an operating system stored in the memory 432, such as Windows Server™, Mac OS X™, Unix™, Linux™, FreeBSD™, etc.

A non-transitory computer-readable storage medium including an instruction, such as a memory 432 including an instruction, is further provided in an example, where the above instruction may be executed by a processing assembly 422 of the apparatus 400, so as to implement the above method. For example, the non-transitory computer-readable storage medium may be an ROM, an RAM, a CD-ROM, a magnetic tape, a floppy disk, an optical data storage device, etc.

It can be further understood that the term “a plurality of” in the disclosure means two or above, and other quantifiers have the similar meanings. The term “and/or,” which describes an association relation of associated objects, indicates that there may be three relations, for example, A and/or B may indicate three situations: A exists alone, both A and B exist, and B exists alone. The character “/” generally indicates that successive association objects are in an “or” relation. The singular forms “a,” “an,” “the,” and “this” are also intended to include the plural forms, unless otherwise clearly stated in the context.

It can be further understood that the terms “first,” “second,” etc., are used to describe various information, but this information should not be limited to these terms. These terms are merely used to distinguish the same type of information from each other, and do not denote any particular order or importance. In fact, the expressions “first,” “second,” etc. can be used interchangeably. For example, first information can also be referred to as second information, and similarly, second information can also be referred to as first information, without departing from the scope of the disclosure.

It can be further understood that although operations are described in the accompanying drawings in particular orders in the examples of the disclosure, it should not be understood that these operations are required to be executed in the particular orders shown or in serial orders, or that all the operations shown are required to be executed to obtained desirable results. In particular circumstances, multitasking and parallel processing may be advantageous.

Other embodiments of the disclosure will readily occur to those skilled in the art upon consideration of the description and practice of the disclosure disclosed here. The disclosure is intended to cover any variations, uses, or adaptive changes of the disclosure that follow the general principles of the disclosure and include common general knowledge or customary technical means in the art not disclosed in the disclosure. The description and the examples are merely deemed illustrative, and the true scope and spirit of the disclosure are indicated by the following claims.

It should be understood that the disclosure is not limited to the precise structures that have been described above and shown in the accompanying drawings, and that various modifications and changes can be made without departing from the scope of the disclosure. The scope of the disclosure is limited merely by the appended claims.

1. A method for determining a discovery burst transmission window (DBTW), performed by a network device and comprising:
determining a working frequency band in an initial access process of a terminal, and determining a DBTW length used by the terminal to transmit in the working frequency band a synchronization signal and physical broadcast channel block in the initial access process; and
sending the DBTW length.

2. The method for determining the DBTW according to claim 1, wherein the sending the DBTW length comprises:
sending physical broadcast channel indication information, wherein the physical broadcast channel indication information is configured to indicate the DBTW length.

3. The method for determining the DBTW according to claim 2, wherein the physical broadcast channel indication information is configured to indicate one or more DBTW lengths.

4. The method for determining the DBTW according to claim 3, wherein the physical broadcast channel indication information is configured to indicate a plurality of DBTW lengths, and different DBTW lengths of the plurality of DBTW lengths are correspondingly configured with different numbers of candidate synchronization signal and physical broadcast channel blocks.

5. The method for determining the DBTW according to claim 3, wherein the physical broadcast channel indication information is configured to indicate two DBTW lengths, and the two DBTW lengths are carried in one bit in sub-carrier indication information of a physical broadcast channel.

6. The method for determining the DBTW according to claim 1, wherein the working frequency band comprises a licensed spectrum, a shared spectrum, or a multiplexed frequency band of the licensed spectrum and the shared spectrum.

7. A method for determining a discovery burst transmission window (DBTW), performed by a terminal and comprising:
determining a working frequency band according to an initial search procedure; and
determining a DBTW length used in a transmission of a synchronization signal and physical broadcast channel block in an initial access process based on the working frequency band.

8. The method for determining the DBTW according to claim 7, wherein the determining the DBTW length used in the transmission of the synchronization signal and the physical broadcast channel block is performed in the initial access process based on the working frequency band comprises:
determining the DBTW length used in the transmission of the synchronization signal and the physical broadcast channel block in the initial access process based on the synchronization signal and physical broadcast channel block identifier parsed in the initial access process in response to determining that the working frequency band is a shared spectrum and sub-carrier spacing is less than a sub-carrier spacing threshold.

9. The method for determining the DBTW according to claim 8, wherein the determining the DBTW length used in the transmission of the synchronization signal and the physical broadcast channel block in the initial access process based on the synchronization signal and the physical broadcast channel block identifier parsed in the initial access process comprises:
determining that no DBTW is used in the transmission of the synchronization signal and the physical broadcast channel block in the initial access process in response to determining that the synchronization signal and the physical broadcast channel block identifier parsed in the initial access process is greater than an identifier threshold.

10. The method for determining the DBTW according to claim 8, wherein the determining the DBTW length used in the transmission of the synchronization signal and the physical broadcast channel block in the initial access process based on the synchronization signal and the physical broadcast channel block identifier parsed in the initial access process comprises:
Determining that the DBTW is used in the transmission of the synchronization signal and the physical broadcast channel block in the initial access process in response to determining that the synchronization signal and the physical broadcast channel block identifier parsed in the initial access process is less than or equal to an identifier threshold.

11. The method for determining the DBTW according to claim 10, wherein the DBTW length is a default DBTW length.

12. The method for determining the DBTW according to claim 7, further comprising:
receiving physical broadcast channel indication information, wherein the physical broadcast channel indication information is configured to indicate the DBTW length used by the terminal to transmit in the working frequency band the synchronization signal and the physical broadcast channel block in the initial access process; and
wherein the determining the DBTW length used in transmission of the synchronization signal and the physical broadcast channel block in the initial access process based on the working frequency band comprises:
determining the DBTW length used in the transmission of the synchronization signal and the physical broadcast channel block in the initial access process based on the physical broadcast channel indication information in response to determining that the working frequency band is a shared spectrum and sub-carrier spacing is greater than a sub-carrier spacing threshold.

13. The method for determining the DBTW according to claim 12, wherein the physical broadcast channel indication information is configured to indicate one or more DBTW lengths.

14. The method for determining the DBTW according to claim 13, wherein different DBTW lengths are correspondingly configured with different numbers of candidate synchronization signal and the physical broadcast channel blocks.

15. The method for determining the DBTW according to claim 12, wherein the physical broadcast channel indication information is configured to indicate two DBTW lengths, and the two DBTW lengths are carried in one bit in sub-carrier indication information of a physical broadcast channel.

16. The method for determining the DBTW according to claim 7, wherein the determining the DBTW length used in the transmission of the synchronization signal and the physical broadcast channel block in the initial access process based on the working frequency band comprises:
Determining that no DBTW is used in the transmission of the synchronization signal and the physical broadcast channel block in the initial access process in response to determining that the working frequency band is a licensed spectrum.

17. The method for determining the DBTW according to claim 7, wherein the determining the DBTW length used in transmission of the synchronization signal and the physical broadcast channel block in the initial access process based on the working frequency band comprises:
determining the DBTW length used in the transmission of the synchronization signal and the physical broadcast channel block in the initial access process based on physical broadcast channel indication information in response to determining that the working frequency band is a multiplexed frequency band of a licensed spectrum and a shared spectrum.

18-19. (canceled)

20. A network device, comprising:
a processor; and
a memory configured to store a processor-executable instruction; wherein
the processor is configured to execute the method for determining the DBTW according to claim 1.

21. A non-transitory computer readable storage medium, storing an instruction, wherein when executed by a processor of a network device, the instruction in the storage medium causes the network device to execute the method for determining the DBTW according to claim 7.

22. A terminal comprising:
one or more processors; and
a memory configured to store a processor-executable instruction;
wherein the one or more processors are collectively configured to:
determine a working frequency band according to an initial search procedure, and determine a DBTW length used in transmission of a synchronization signal and physical broadcast channel block in an initial access process based on the working frequency band.
